(19) United States
(12) Patent Application Publication
(10) Pub. No.: US 2009/0010016 A1
(43) Pub. Date: Jan. 8, 2009

(54) VEHICLE LIGHTING DEVICE

(75) Inventors: Shuei-Yuan Lee, Taipei City (TW); Pei-Hsin Pei, Taipei City (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: ACXING INDUSTRIAL CO., LTD., Taipei City (TW)

(21) Appl. No.: 11/962,831

(22) Filed: Dec. 21, 2007

(30) Foreign Application Priority Data
Jul. 4, 2007 (TW) 096124308

(51) Int. Cl. G09B 15/02

(52) U.S. Cl. 362/475

(57) ABSTRACT

A vehicle lighting device is mounted in a bicycle. The lighting device includes a cantilever, a light-emitting lamp, and a power generating unit. The cantilever is fixed on a frame of the bicycle, so as to support the power generating unit to urge the power generating unit against a wheel of the bicycle constantly. The power generating unit includes an induction coil winding, a magnetic rotor, and a roller. The induction coil winding is wound around a winding axis. A rotating axis of the magnetic rotor is perpendicular to the winding axis. When wheels of the bicycle rotate, the roller and the magnetic rotor are driven to rotate relative to the induction coil winding, such that the induction coil winding generates an inductive electric power, which is supplied to the light-emitting lamp. Thus, a low-cost and labor-saving vehicle lighting device is developed.

### CROSS-REFERENCE TO RELATED APPLICATIONS

This non-provisional application claims priority under 35 U.S.C. § 119(a) on Patent Application No(s). 096124308 filed in Taiwan, R.O.C. on Jul. 4, 2007, the entire contents of which are hereby incorporated by reference.

### BACKGROUND OF THE INVENTION

1. Field of Invention

The present invention relates to a lighting apparatus in which power is supplied by rotation of wheels, and more particularly to a vehicle lighting device applied to a bicycle, which provides sufficient lighting without increasing resistance to ride the bicycle, and reduces cost of part development.

2. Related Art

Unlike motorcycles or cars, conventional bicycles do not includes power supply apparatus, such as batteries for vehicles and power generators, so light-emitting lamps or alarming devices cannot be mounted on the conventional bicycles. Therefore, when moving at night or in areas where light is insufficient, the conventional bicycles often lead to traffic accidents as vision of riders is unclear or no bright alarming signs are provided on the bicycles. Then, because of the need for safety, passive alarming devices such as reflective plates or reflective pasters are added to the bicycles, so as to give alarms through the reflection of light. However, the passive alarming devices can function normally only when light shines on them, and they cannot illuminate the vision of the riders. In order to provide sufficient lighting and alarming light when the bicycles are ridden at night to prevent accidents and dangers, some bicycles have active lighting apparatus or alarming apparatus, e.g., lightings including bulbs or LEDs, most of which use power supplied by batteries currently. However, the batteries are consuming products with certain valid periods. After the power is used out, the batteries must be replaced regularly. Therefore, these apparatus often do not work when the batteries are not replaced in time. Moreover, most batteries include heavy metals, which must be recovered, so the application of these apparatus is inconvenient and not environment-friendly.

With the progress of science and technology, many simple power generating tools converting mechanical power to electric power have been developed. These tools will not cause pollution to the environment, and can save power at the same time, so they are applied more and more widely now. Electromagnetic power generators for supplying power to active lighting or alarming apparatus of bicycles are one of these tools. However, in a conventional generator structure for bicycles, a driving element of the generator is directly urged against a surface of a tire of the bicycle, so much labor must be cost to ride the bicycle.

For example, Taiwan Patent No. 1241971 provides a hub-type power generator that generates power from the rotation of a wheel of a bicycle, so as to supply power to lighting apparatus in the bicycle. Though Patent No. 1241971 achieves the objective of power generating and lighting, the power generating mechanism is disposed with the hub of the wheel, so accommodation space and arrangement of power lines for the power generating mechanism must be considered during the design of the hub of the wheel, causing more trouble to the development and manufacturing of the products. Moreover, as the hub and the power generating mechanism include many complicated small parts, the subsequent assembling becomes complicated and time-consuming. These factors eventually lead to a relative increase of the cost of the products. Further, the hub-type power generators must be sold together with special bicycles, as they cannot be added to normal conventional bicycles or sold to consumers individually for them to assemble by themselves. Therefore, the consumers may be less willing to buy such products. In addition, when a user rides a bicycle with the hub-type power generator, the load of current makes the magnet in the power generator to attract the iron parts, so the resistance to ride the bicycle is increased, making the bicycle difficult to ride.

For example, Taiwan Utility Model Patent No. M308563 provides another external power generator for a bicycle, which uses rotation of a wheel of the bicycle to generate power. In this power generator, the wheel drives an induction coil winding to rotate relative to a magnet, so as to generate inductive electric power to supply the required power. Patent No. M308563 is a structural modification to a power generator of a bicycle, and includes a rotor, a magnet, two iron claw seats, a coil winding, a bearing, and a cover. A plurality of buckles for buckling spokes of the wheel of the bicycle is disposed on a side of the rotor, and a hollow cylinder is disposed at a center of the other side of the rotor. The magnet is ring-shaped, and sleeves on an outer periphery of the hollow cylinder of the rotor for fixing. The two iron claw seats are arranged opposite to each other, and sleeve on an outer side of the magnet. The coil winding is clamped between the two iron claw seats. The bearing is sleeved in the two iron claw seats, and is attached on the magnet. The cover is assembled on the rotor, and is fastened with the two iron claw seats for fixing, so as to limit the movement of the coil winding. Thus, when the bicycle moves, the coil winding will generate power for lighting, alarming or charging a secondary battery. However, the induction coil winding of Patent No. M308563 is wound around the outside of the magnet, so the magnetic change relative to the induction coil winding when the magnet rotates cannot pass through the enclosed area surrounded by the induction coil winding (in terms of magnetic flux), or at most a very small portion of the magnetic change can pass through the area.

### SUMMARY OF THE INVENTION

In the conventional light-emitting lamp of a bicycle using batteries, the batteries must be replaced regularly, which is troublesome and not environment-friendly. Moreover, as for current bicycles using a power generator to supply power to a light-emitting lamp, the development cost is high, and the power generating performance is poor. Accordingly, the present invention is directed to providing a vehicle lighting device, so as to solve the problems of the light-emitting lamps of bicycles currently.

In order to solve the above problems, the present invention provides a vehicle lighting device mounted on a vehicle. The vehicle can be, but is not limited to, a bicycle. The vehicle lighting device includes a light-emitting lamp, a fixing base, and a power generating unit. The vehicle at least includes a wheel and a frame on which the wheel is pivoted. The wheel has a relative displacement with the frame when rotating. The light-emitting lamp is mounted on the fixing base, or is directly fixed on the vehicle, so as to provide lighting. The fixing base includes a jig, a cantilever, and a box. The jig clips the frame of the vehicle, so as to mount the fixing base on the vehicle. A first end of the cantilever extends out from the jig, and a second end of the cantilever extends toward the wheel. The box is disposed on the second end of the cantilever, and is arranged on a side of the wheel. The power generating unit is mounted on the second end of the cantilever, and includes a body, at least one induction coil winding, a magnetic rotor, and a roller. The body is disposed in the box of the fixing base. The induction coil winding is wound on a surface of the body around a winding axis, and is electrically connected to the light-emitting lamp. The magnetic rotor is pivoted in the body, and rotates relative to the body about a rotating axis. An angle is formed between the rotating axis of the magnetic rotor and the winding axis of the induction coil winding. The roller is connected to the magnetic rotor, and is constantly urged against an outer periphery of the wheel. When the wheel rotates, the magnetic rotor is driven to rotate relative to the induction coil winding, such that the induction coil winding is induced by a magnetic field change to generate an inductive electric power, which is supplied to the light-emitting lamp for emitting light. The cantilever absorbs the relative displacement when the wheel rotates.

The effects of the present invention are as follows. The power generating unit is mounted on the bicycle (vehicle) with the fixing base, and the cantilever allows the wheel to continuously drive the power generating unit to generate the power supplied to the light-emitting lamp. Thus, the trouble of replacing the batteries is removed, the environment protection concept is realized, and the development cost of power supply devices is reduced. Therefore, the user can buy the lighting device at a low price and assemble it on the current bicycle (vehicle). In addition, the magnetic rotor in the power generating unit will not attract parts around it because of a load of current, so the bicycle is labor-saving when riding.

### BRIEF DESCRIPTION OF THE DRAWINGS

The present invention will become more fully understood from the detailed description given herein below for illustration only, and thus are not limitative of the present invention, and wherein:

FIG. 1 is a schematic isometric view of the vehicle lighting device mounted on a front side of a bicycle according to a first embodiment of the present invention;

FIG. 2 is a schematic view of the configuration of the vehicle lighting device of the present invention and a wheel;

FIG. 3 is an exploded isometric view of the light generating unit of the vehicle lighting device of the present invention;

FIG. 4A is a schematic isometric view of the light generating unit of the vehicle lighting device of the present invention;

FIG. 4B is a schematic isometric view of the light generating unit of the vehicle lighting device of the present invention;

FIG. 5 is a schematic isometric view of the induction coil windings wound on the light generating unit of the vehicle lighting device of the present invention;

FIG. 6 is an exploded isometric view of the light generating unit and the fixing frame of the vehicle lighting device of the present invention;

FIG. 7 is a schematic isometric view of the vehicle lighting device mounted on a front side of a bicycle according to a second embodiment of the present invention; and

FIG. 8 is a schematic isometric view of the vehicle lighting device mounted on a rear side of a bicycle according to a third embodiment of the present invention.

### DETAILED DESCRIPTION OF THE INVENTION

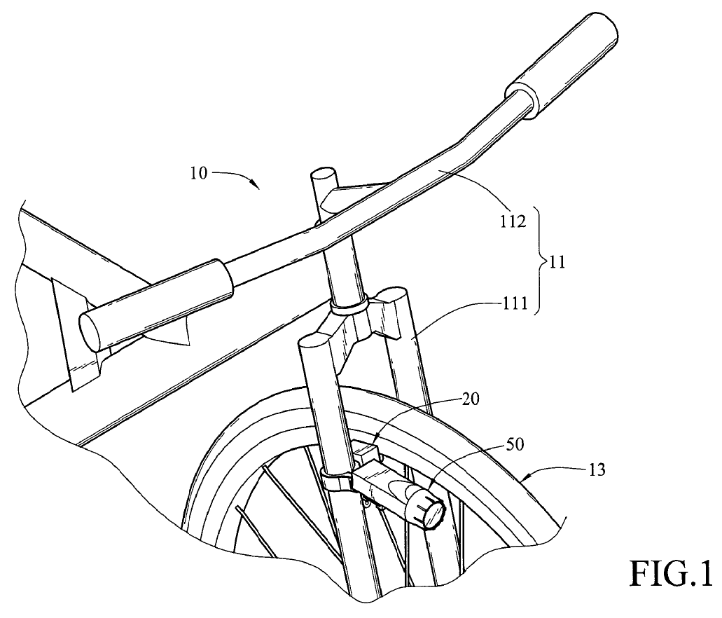

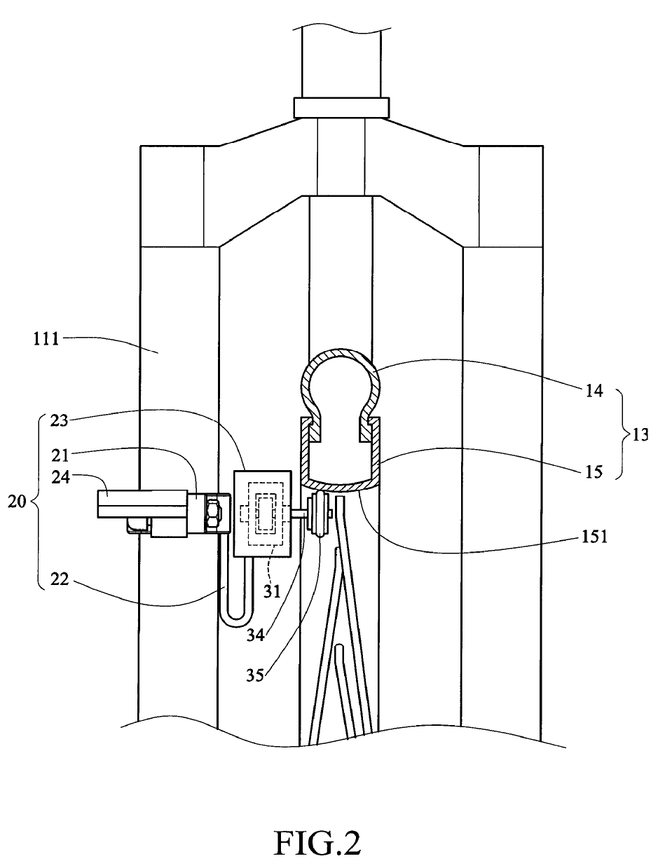

FIGS. 1 and 2 show a first embodiment of a vehicle lighting device of the present invention. Referring to FIGS. 1 and 2, the vehicle lighting device includes a fixing base 20, a power generating unit 30, and a light-emitting lamp 50. The vehicle lighting device is mounted on a vehicle 10, which may be a bicycle. The bicycle 10 includes a wheel 13 and a frame 11, and the frame 11 includes a fork 111 and a handlebar 112. The wheel 13 is pivoted on the fork 111 of the frame 11, so as to drive the power generating unit 30 to generate power. Thus, the power generating unit 30 supplies power to the light-emitting lamp 50. The wheel 13 includes a tire portion 14 for shock absorption and a wheel portion 15 for support. When the wheel 13 rotates, the wheel portion 15 is not perfectly circular, so an outer periphery 151 of the wheel part will have a relative displacement to the frame 11. Here, the relative displacement is the displacement of the outer periphery 151 of the wheel portion 15 in a radial or axial direction of the wheel 13.

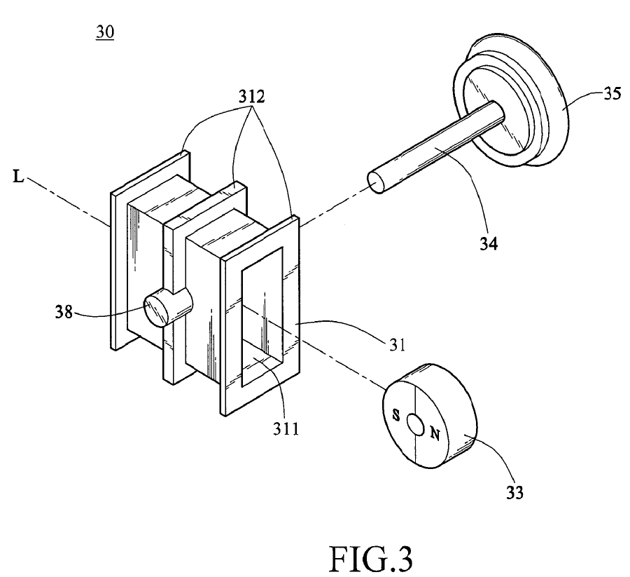

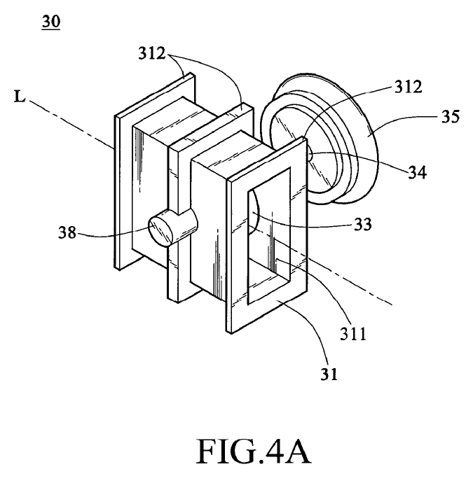

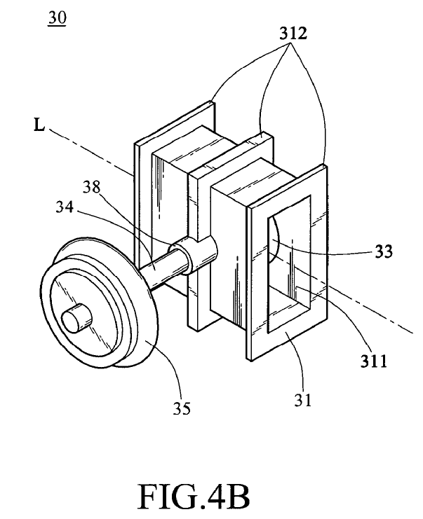

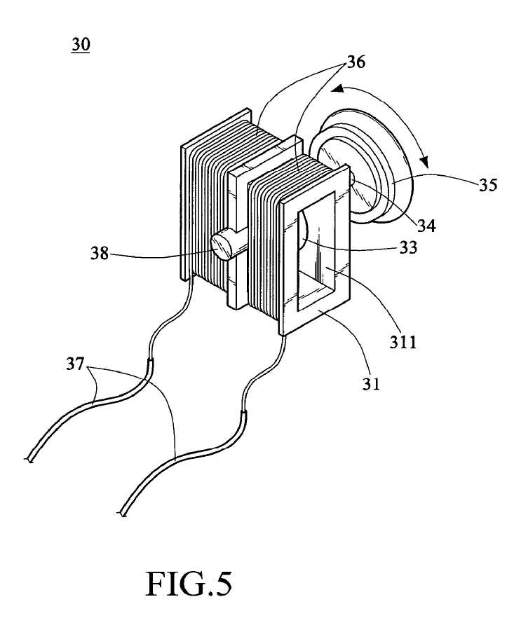

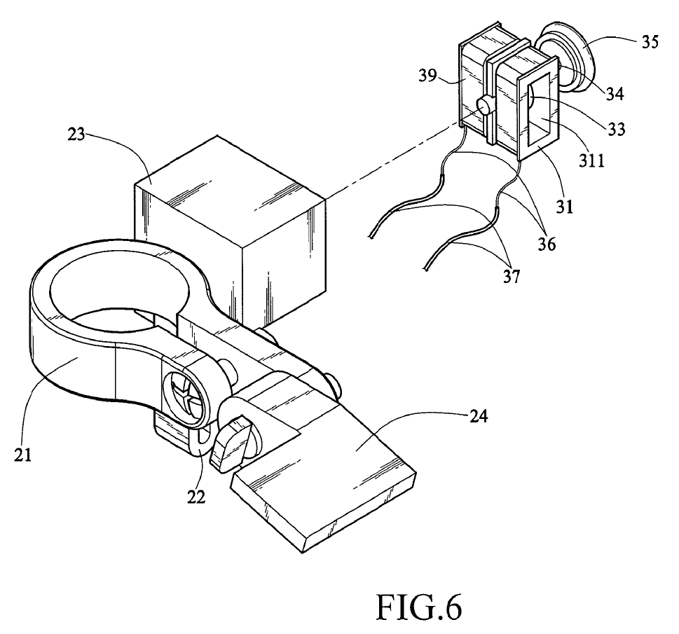

Referring to FIGS. 2, 3, 4A, 4B, 5, and 6, the fixing base 20 is an irregular base mounted on the fork 111, and includes a jig 21, a cantilever 22, a box 23, and an assembling portion 24. The jig 21 clips on the fork 111 of the frame 11 by screw fixing, so as to fix the fixing base 20 on the frame 11 of the vehicle 20. However, the method of fixing the fixing base 20 and the fork 111 is not limited to be so. The cantilever 22 has a first end and a second end. The first end of the cantilever 22 extends from a lower edge of the jig 21 to the center of the wheel 13, and is fixed to the frame 11 with the jig 21. Then, the cantilever 22 bends to further extend towards the outside along a radial direction of the wheel 13, and forms a flexible support structure on a side of the jig 21. The box 23 is fixed on the second end of the cantilever 22, and is disposed on a side of the wheel portion 15 of the wheel 13. The box 23 is hollow. The assembling portion 24 is disposed on a side of the jig 21 for mounting the light-emitting lamp 50.

The power generating unit 30 is installed in the box 23, and thus is mounted on the second end of the cantilever 22 through the box 23. Moreover, the power generating unit 30 is fixed on the fork 111 of the frame 11. The power generating unit 30 includes a body 31, a magnetic rotor 33, an axle 34, a roller 35, an induction coil winding 36, a wire 37, and a bearing 38. The number of the induction coil winding 36, the wire 37, and the bearing 38 can be increased according to actual requirements. In this embodiment, two induction coil windings 36, two wires 37, and two bearings 38 are used to implement the present invention. The body 31 is hollow, and can be, but is not limited to, a rectangular shell. An opening 311 towards outside is formed in each of two opposite ends of the body 31, and a plurality of spacing ribs 312 is formed on an outer surface of the body 31. The body 31 is installed in the box 23 of the fixing base 20, such that the power generating unit 30 is fixed on the fixing base 20, and is disposed on a side of the wheel portion 15 of the wheel 13. The magnetic rotor 33 is a pair of disk-shaped magnets with opposite magnetic poles. The adjacent magnetic poles are different. Moreover, the magnetic rotor 33 can have only a pair of opposite magnetic poles, or have two or more pairs of opposite magnetic poles. The bearings 38 are disposed at central positions of two opposite side surfaces of the body 31. The axle 34 is pivoted on the body 31 through the bearings 38, so as to reduce the frictional resistance, such that the axle 34 can move relative to the body 31 smoothly. An end of the axle 34 is connected with the roller 35, and the other end penetrates and is connected with the magnetic rotor 33. Thus, the axle 34 enables the roller 35 and the magnetic rotor 33 to rotate synchronously, i.e., the roller 35 and the magnetic rotor 33 rotate relative to the body 31 at the same time. The induction coil windings 36 are wound on the surface of the body 31 about a winding axis L, which is the axial direction perpendicular to the breadth of the spacing ribs 312. Each of the induction coil windings 36 is wound on the surface of the body 31 in one of two areas defined by the spacing ribs 312. After the induction coil windings 36 are wound on the body 31, a protective layer 39 is coated outside the induction coil windings 36, so as to provide the effects of insulation and protection.

An angle is formed between the rotating axis of the magnetic rotor 33 and the winding axis L, such that the magnetic rotor 33 rotates with the winding axis L at an angle, and the magnetic rotor 33 is located in an enclosed region surrounded by the induction coil windings 36. In this embodiment, the rotating axis of the magnetic rotor 33 is orthogonal to the winding axis L. The roller 35 is connected with the magnetic rotor 33 by the axle 34, and is constantly urged against the outer periphery 151 of the wheel portion 15 of the wheel 13 by the cantilever 22, such that the roller 35 is in continuous contact with the outer periphery 151. The wires 37 are electrically connected to the induction coil windings 36 and the light-emitting lamp 50 respectively, so as to output the inductive electric power generated by the induction coil windings 36 to the light-emitting lamp 50, and to provide the power required by the light-emitting lamp 50 to emit light.

When the vehicle 10 moves to drive the wheel 13 to rotate, the roller 35 is constantly in contact with the outer periphery 151 of the wheel 13, so the wheel 13 can drive the roller 35 to rotate. Meanwhile, the roller 35 uses the axle 34 to drive the magnetic rotor 33 to rotate relative to the induction coil windings 36, and relative positions of the magnetic poles of the magnetic rotor 33 of the induction coil windings 36 will move accordingly, such that the magnetic field around the induction coil windings 36 changes continuously. The change of the magnetic field means that the induction coil windings 36 will generate magnetic flux correspondingly. As the rotating axis of the magnetic rotor 33 is orthogonal to the winding axis L, and the magnetic rotor 33 is disposed in the enclosed region surrounded by the induction coil windings 36, the magnetic flux will pass through the enclosed area surrounded by the induction coil windings 36. Thus, the induction coil windings 36 can be induced by the change of the magnetic field (magnetic flux), and generate the inductive electric power. Next, the inductive electric power can be input into the light-emitting lamp 50 through the wires 37, so as to provide the power required by the light-emitting lamp 50.

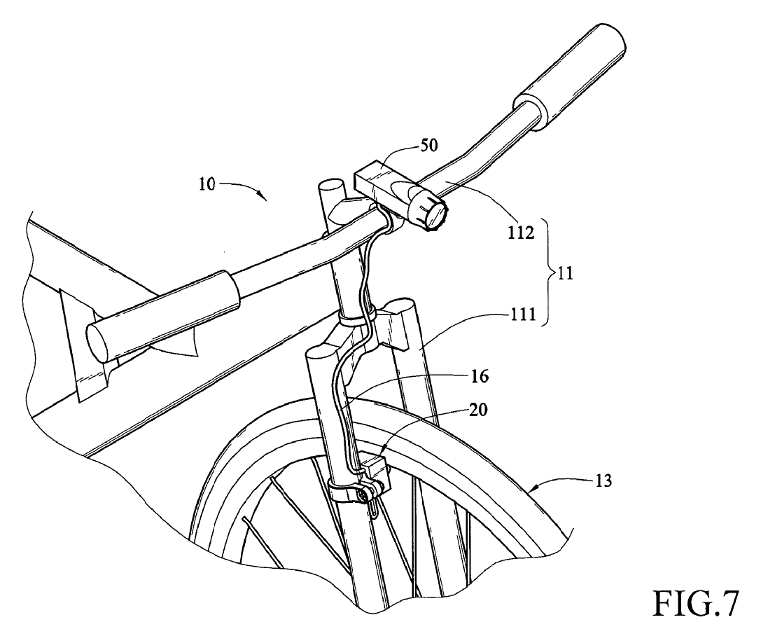

FIG. 7 shows a second embodiment of the vehicle lighting device of the present invention, which is substantially the same as the first embodiment. However, the main difference between the second embodiment and the first embodiment is as follows. The light-emitting lamp 50 is fixed on the handlebar 112 of the frame 11, so as to be directly mounted on the vehicle 10. In addition, the vehicle lighting device further includes a power line 16 linked to the wires 37 of the power generating unit 30 and electrically connected to the light-emitting lamp 50, so as to transmit the inductive electric power generated by the power generating unit 30 to the light-emitting lamp 50. However, the mounting position of the light-emitting lamp 50 is not limited to the handlebar 112 of the frame 11. Instead, the light-emitting lamp 50 can be mounted in other parts of the frame 11 of the vehicle 10 according to actual requirements.

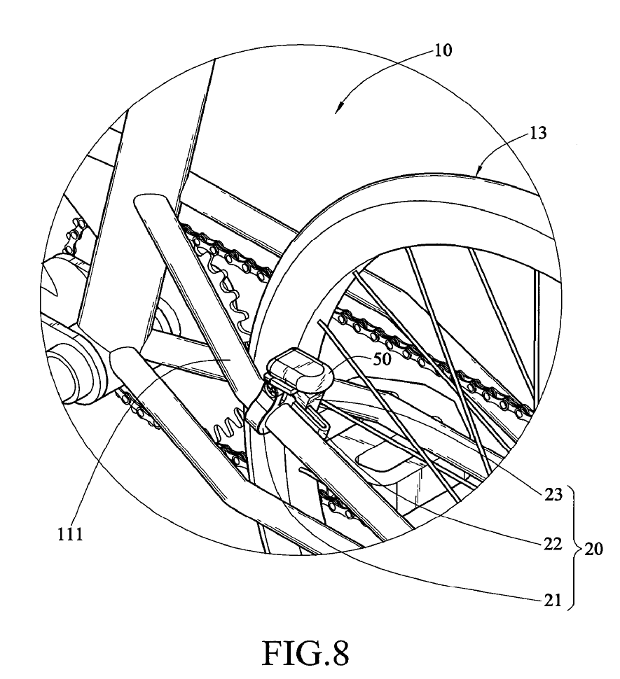

FIG. 8 shows a third embodiment of the vehicle lighting device of the present invention. In this embodiment, the vehicle lighting device is mounted on the rear side of the vehicle 10, and the light-emitting lamp 50 is an alarming lamp to provide alarms. The jig 21 of the fixing base 20 clips on the fork 111 at the rear side of the vehicle 10, and the light-emitting lamp 50 is mounted on the fixed base 20. The cantilever 22 of the fixing base 20 supports the box 23 at one side of the rear wheel 13 of the vehicle 10, and the wheel 13 drives the vehicle lighting device to generate power continuously.

To sum up, the power generating unit 30 of the present invention is mounted on the bicycle (vehicle 10) with the fixing base 20, and the cantilever 22 allows the wheel 13 to continuously drive the power generating unit 30 to generate the power supplied to the light-emitting lamp 50. Thus, the trouble of replacing the batteries is removed, the environment protection concept is realized, and the development cost of power supply devices is reduced. Therefore, the user can buy the lighting device at a low price and assemble it on the current bicycle. In addition, the magnetic rotor 33 in the power generating unit 30 will not attract parts around it because of a load of current, so the bicycle is labor-saving when riding.

What is claimed is:

1. A vehicle lighting device, mounted on a vehicle at least having a wheel and a frame for pivoting the wheel, wherein the wheel has a relative displacement with the frame when rotating, the vehicle lighting device comprising:
a light-emitting lamp;
a cantilever, having a first end and a second end, wherein the first end is fixed to the frame, and the second end extends toward the wheel; and
a power generating unit, mounted on the second end of the cantilever, comprising:
a body;
at least one induction coil winding, wound on a surface of the body around a winding axis, and electrically connected to the light-emitting lamp;
a magnetic rotor, pivoted in the body, and rotating relative to the body about a rotating axis, wherein an angle is formed between the rotating axis and the winding axis; and
a roller, connected to the magnetic rotor, and constantly urged against an outer periphery of the wheel through the support of the cantilever, wherein when the wheel rotates, the magnetic rotor is driven to rotate relative to the induction coil winding, such that the induction coil winding is induced by a magnetic field change to generate an inductive electric power, which is supplied to the light-emitting lamp for emitting light, and the cantilever absorbs the relative displacement when the wheel rotates.

2. The vehicle lighting device as claimed in claim 1, wherein the light-emitting lamp is mounted on the vehicle.

3. The vehicle lighting device as claimed in claim 1, further comprising a jig clipping the frame, wherein the cantilever extends out from the jig.

4. The vehicle lighting device as claimed in claim 3, further comprising an assembling portion disposed on the jig for mounting the light-emitting lamp.

5. The vehicle lighting device as claimed in claim 1, further comprising a box fixed on the second end of the cantilever, wherein the body of the power generating unit is disposed in the box.

6. The vehicle lighting device as claimed in claim 1, further comprising two wires electrically connected to the induction coil winding and the light-emitting lamp respectively, for supplying the inductive electric power to the light-emitting lamp.

7. The vehicle lighting device as claimed in claim 1, further comprising an axle pivoted on the body and connecting the magnetic rotor and the roller.

8. The vehicle lighting device as claimed in claim 1, wherein the magnetic rotor is formed by at least one pair of opposite magnetic poles.
